(19) United States
(12) Patent Application Publication
(10) Pub. No.: US 2004/0035931 A1
(43) Pub. Date: Feb. 26, 2004

(54) Integrated optical apparatus

(76) Inventors: Tamiaki Matsuura, Kanagawa (JP); Hidekuni Aizawa, Kanagawa (JP); Shigeru Shinzawa, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/162,757

(22) Filed: Jun. 6, 2002

(30) Foreign Application Priority Data
Jun. 8, 2001 (JP) P2001-173491

(51) Int. Cl. G06K 7/10; G06K 7/14

(52) U.S. Cl. 235/454

(57) ABSTRACT

In order to obtaining an integrated optical apparatus in which a moving mirror and a frame may be omitted and which can be assembled in an integrated structure including a pivoting part, there is provided an integrated optical apparatus including: a projection and photodetection package containing therein a light emitting element, a projection lens, a photodetecting element, and a light receiving lens; a flexible thin sheet having elastic properties; the end of the flexible thin sheet being fixed to the light projection and photodetection package and the base end of the flexible thin sheet being fixed to a fixed portion to pivotably support the light projection and photodetection package to the fixed portion; and a projection and photodetection package pivoting means provided over both the light projection and photodetection package and the fixed portion.

### CROSS REFERENCE TO RELATED APPLICATIONS

This application claims priority to Japanese Patent Application No. JP 2001-173491, filed on Jun. 8, 2001, the disclosure of such application being herein incorporated by reference to the extent permitted by law.

### BACKGROUND OF THE INVENTION

1. Field of the Invention

The present invention relates to an integrated optical apparatus for barcode reading. More specifically, relates to an improvement technology, in which a light projection and photodetection package including a light emitting element, a light receiving element, and an optical system are pivotably supported by a flexible thin sheet, so that a moving mirror for moving the emitted light for scanning is no longer required.

2. Description of the Related Art

It has become common practice in shops and factories to attach to a product, a barcode representing digital data, so that by reading the digital data by optically scanning the barcode, it is possible to perform sales management, production control and the like for the products. In this type of barcode, strength of reflected light resulting from irradiation of light to the barcode is photoelectrically converted so as to read the data from the combination of the detected signals.

In other words, as shown in the explanatory view of FIG. 8, light emitted from a light emitting element 1 is focused by means of a light emission lens 3, and the resultant light is reflected by a mirror 7 of a scanning mirror 5 and then sent to a barcode 9. For sending the light all over the barcode 9, there is a need to pivot the mirror 7. The mirror 7 is pivoted using a pivot shaft 15 as a support by inserting a magnet 11 fitted to the mirror 7 into a driving coil 13, and, for example, making electric current flow through the driving coil 13 in opposite directions alternately in a predetermined cycle so that the magnet 11 alternately attracts and repels the driving coil 13.

On the other hand, the light emitted to the surface of the barcode 9 undergoes irregular reflection but surely returns to the mirror 7, accompanied by a change of the light amount due to the black and white of the barcode, and the light reflected by the mirror is condensed by means of a condensing lens 17, and then electrically converted by a photodetecting element 19 in respect of the change of the light amount to output the data.

In order to improving the reading accuracy, a band pass filter (BPF) 21 is provided on the front wall of the photo detecting element 19 to prevent lighting of unnecessary light at frequencies other than the frequency of the light emitted.

As an example in which the above-mentioned barcode reading system is applied to an apparatus, an optical apparatus for barcode reading shown in FIG. 9 is provided.

Such an optical apparatus has a construction such that, as shown in the figure, a light emitting mechanism A containing in a housing 25 a light emitting element 1 and a light emission lens 3, and a photodetecting mechanism B containing in a housing 27 a photodetecting element 19, a light receiving lens 17, and a BPF 21 are mounted on a substrate 29.

The electrical connection in each of the housings 25, 27 is achieved by wire bonding or the like. A mirror 7 of a scanning mirror 5 is pivotably disposed using a pivot shaft 15 as a support.

The light emitting mechanism A, the photodetecting mechanism B, and the scanning mirror 5 are contained in a frame (not shown) to form an optical apparatus for barcode reading.

However, in the above-mentioned optical unit for barcode reading, generally, the light emitting element, the photodetecting element and the like are fixed, and the moving mirror is pivoted to move the emitted light for scanning. Therefore, a frame for combining these individual parts in an integrated form is needed, and further a space in which the moving mirror is disposed is also needed, so that the number of the parts used is inevitably increased, thus making it difficult to further reduce the size and weight of the unit. In addition, there is a need to adjust the relative position between the light emitting and photodetecting elements and the moving mirror, leading to a problem in that the number of the steps for the assembly and adjustment operations is increased. Further, since the unit has a frame, the capability of the unit of being embedded into the main body apparatus is inevitably limited, so that the design freedom of the apparatus is disadvantageously low.

### SUMMARY OF THE INVENTION

The present invention has been conceived in view of the above-mentioned problems associated with the related art, and it is desirable to provide an integrated optical apparatus which is advantageous not only in that a moving mirror and a frame may be omitted, but also in that the apparatus can be assembled in an integrated structure including a pivoting part, thus achieving reduction in the size and weight of the apparatus and simplified operations for assembly and adjustment as well as improvement of the incorporation property of the apparatus into the main body apparatus.

In order to alleviating the mentioned problems, it is desirable to provide an integrated optical apparatus including: a projection and photodetection package having a light emitting element, a projection lens, a photodetecting element, and a light receiving lens; a flexible thin sheet having elastic properties, the end of the flexible thin sheet being fixed to the light projection and photodetection package, and the base end of the flexible thin sheet being fixed to a fixed portion to pivotably support the light projection and photodetection package to the fixed portion; and a projection and photodetection package pivoting means provided over both the light projection and photodetection package and the fixed portion.

In such an integrated optical apparatus according to a preferred embodiment of the present invention, the light emitting element, the photodetecting element, and other optical systems are contained in the light projection and photodetection package, the light projection and photodetection package is supported to the fixed portion through the flexible thin sheet, and the light projection and photodetection package pivoting means is provided over both the light projection and photodetection package and the fixed portion. Thus, the apparatus having an integrated structure. Further, the light projection and photodetection package as one constituent of the apparatus may be directly pivoted. For this reason, a moving mirror and a frame for combining individual parts in an integrated form are no longer required. In addition, no adjustment for the moving mirror is required. Further, since the frame can be omitted, not only can the size of the apparatus be reduced, but also the embedment property of the apparatus into the main body apparatus (flexibility embedding the apparatus) is enhanced, thus increasing the design freedom of the apparatus.

An integrated optical apparatus according to another preferred embodiment of the present invention may further include: an element lead which is electrically connected to each of the light emitting element and the photodetecting element and which is lead out from the light projection and photodetection package; and a fixed lead provided in the fixed portion; the flexible thin sheet may be formed from a conductive material; the element lead and the fixed lead may be connected and fixed through a plurality of the conductive flexible thin sheets.

In such an integrated optical apparatus, the element lead, which is lead out from the light projection and photodetection package, and the fixed lead provided in the fixed portion may be connected through the flexible thin sheet comprised of a conductive material. Therefore, the flexible thin sheet not only serves as a hinge for pivotably supporting the light projection and photodetection package but also electrically connects the light emitting element and photodetecting element to be pivoted. In other words, a pivotably supporting means can serve as an electric wiring means, thus making it possible to reduce the number of the parts used. In addition, connection is possible anytime through the flexible thin sheet without a sliding part. Therefore, the wear to which the electric sliding part is subject can be substantially reduced, thus realizing a pivotably electrically connected structure having high fastness and long life.

According to an integrated optical apparatus according to another preferred embodiment of the present invention, the element lead, the conductive flexible thin sheet, and the fixed lead may be combined in an integrated form by a material having elastic properties and conductivity.

In such integrated optical apparatus, the base end of the conductive flexible thin sheet is fixed to the fixed portion, and the light projection and photodetection package is fixed to the end of the conductive flexible thin sheet. In this case, the electrodes of the light emitting element and the photodetecting element are individually directly connected to the conductive flexible thin sheets. Therefore, neither an element lead nor a fixed lead are required, so that the connection and fixing between the flexible thin sheet and the element lead and between the flexible thin sheet and the fixed lead by soldering or the like are not required. Thus, not only can the number of the parts used be further reduced, but also the reliability of the electrical connection and the reliability of the pivotably supported structure are further improved.

According to an integrated optical apparatus according to another preferred embodiment of the present invention, the light projection and photodetection package pivoting means may comprise a magnetic material fixed to the light projection and photodetection package, and a driving coil fixed to the fixed portion.

In such embodiment of the integrated optical apparatus, when electric current flows through the coil provided in the fixed portion, magnetic flux occurs to generate force that attracts the magnetic material. As a result, when an electrical signal having a different phase is applied to the coil, the conductive flexible thin sheet is elastically deformed to pivot the light projection and photodetection package. In this structure, by virtue of providing the coil in the fixed portion, the number of the conductive flexible thin sheets used for the light projection and photodetection package can be lowered, as compared to the structure in which the coil is provided in the light projection and photodetection package.

According to an integrated optical apparatus according to another preferred embodiment of the present invention, the light projection and photodetection package pivoting means may comprise a driving coil fixed to the light projection and photodetection package, and a magnetic material fixed to the fixed portion.

In such embodiment for the integrated optical apparatus, when an electrical current flows through the coil provided in the light projection and photodetection package thorough the conductive flexible thin sheet, a magnetic flux occurs to generate a force that attracts the magnetic material. As a result, when an electrical signal having a different phase is applied to the coil, the conductive flexible thin sheet is elastically deformed to pivot the light projection and photodetection package. In such structure, by virtue of providing a lightweight coil in the light projection and photodetection package, not only the weight of the light projection and photodetection package but also the driving force for the light projection and photodetection package can be reduced, as compared to the case in which magnetic material is provided in the light projection and photodetection package.

### BRIEF DESCRIPTION OF THE DRAWINGS

The above and other objects, features and advantages of the present invention will become more apparent to those skilled in the art from the following description of the presently preferred exemplary embodiments of the invention taken in conjunction with the accompanying drawings, in which:

FIG. 1 shows a diagrammatic cross-sectional view of a portion of an integrated optical apparatus, according to a preferred embodiment of the present invention;

FIG. 2 shows a diagrammatic view as viewed in the direction indicated by the arrows A-A in FIG. 1, according to a preferred embodiment of the present invention;

FIG. 3 shows a diagrammatic view as viewed in the direction indicated by the arrows B-B in FIG. 2, according to a preferred embodiment of the present invention;

FIG. 4 shows a diagrammatic view as viewed in the direction indicated by the arrows C-C in FIG. 3, according to a preferred embodiment of the present invention;

FIG. 5 shows a diagrammatic plan view of an integrated optical apparatus before bending a flexible thin sheet, according to a preferred embodiment of the present invention;

FIG. 6 shows a diagrammatic view as viewed in the direction indicated by the arrows D-D in FIG. 5, according to a preferred embodiment of the present invention;

FIG. 7 shows a diagrammatic cross-sectional view of a portion of an integrated optical apparatus, showing a pivotable feature of a light projection and photodetection package, according to a preferred embodiment of the present invention;

FIG. 8 shows a schematic view illustrating a conventional optically reading method; and

FIG. 9 shows a diagrammatic cross-sectional view of a conventional optical barcode reading apparatus.

### DETAILED DESCRIPTION OF THE PREFERED EMBODIMENTS OF THE INVENTION

Preferred embodiments for an integrated optical apparatus according to the present invention will be described in detail with reference to the accompanying drawings.

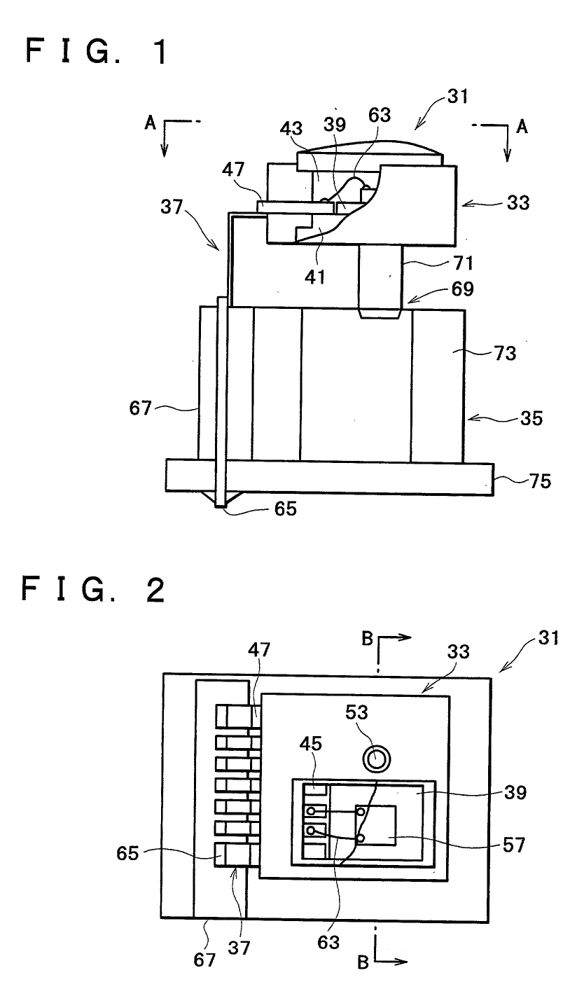

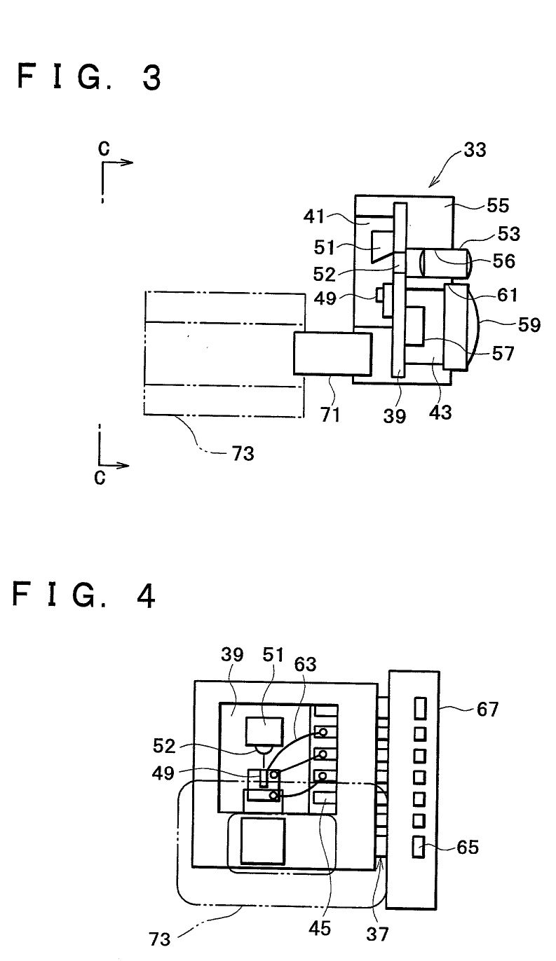

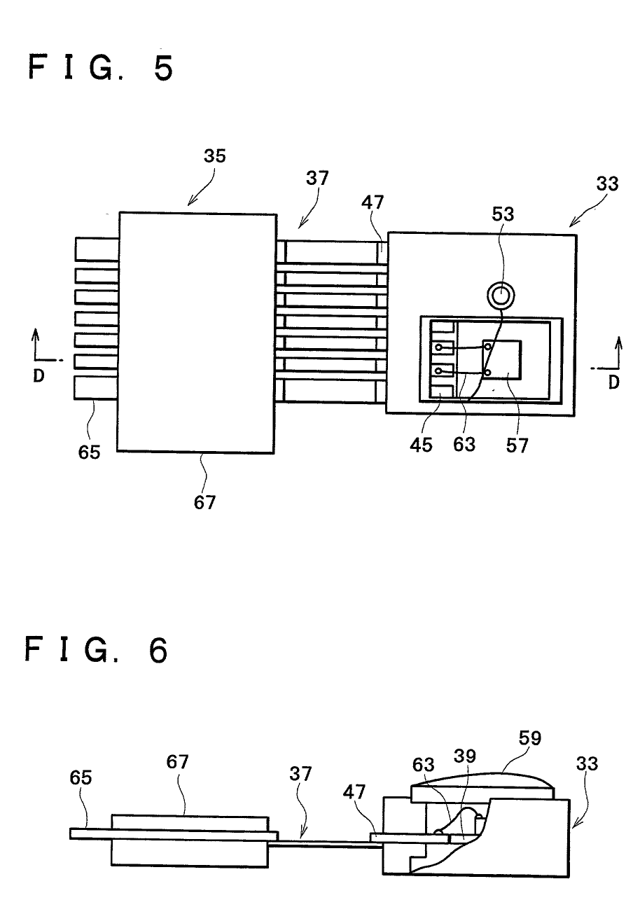

FIG. 1 shows a diagrammatic cross-sectional view of an integrated optical apparatus of the present invention; FIG. 2 shows a diagrammatic view as viewed in the direction indicated by the arrows A-A in FIG. 1; FIG. 3 shows a diagrammatic view as viewed in the direction indicated by the arrows B-B in FIG. 2; FIG. 4 shows a diagrammatic view as viewed in the direction indicated by the arrows C-C in FIG. 3; FIG. 5 shows a diagrammatic plan view of an integrated optical apparatus before bending a flexible thin sheet; and FIG. 6 shows a diagrammatic view as viewed in the direction indicated by the arrows D-D in FIG. 5.

In an integrated optical apparatus 31 according to the preferred embodiment of the present invention, the main constituents comprise a projection and photodetection package 33, a fixed portion 35, and a flexible thin sheet 37 which pivotably connects the light projection and photodetection package 33 to the fixed portion 35.

The light projection and photodetection package 33 has a die pad 39 at a substantially central portion thereof. On the upper and lower sides of the die pad 39 in the light projection and photodetection package 33, two cavities 41, 43 for chip mounting are present through the die pad 39. The cavities 41, 43 have therein a plurality of lands 45 for wire bonding shown in FIG. 2. Each of the lands 45 for wire bonding independently serves as an element lead 47 to lead out from one side of the light projection and photodetection package 33 to the outside.

On a back or bottom surface of the die pad 39 (corresponding to a surface on the bottom side in FIG. 1) that is one of the surfaces of the die pad 39, there is mounted a light emitting element 49 contained in the cavity 41 shown in FIG. 3. Near the light emitting element 49 is mounted a mirror 51 fixed at 45° for changing the direction of a light emitted from the light emitting element 49 by 90°. Near the mirror 51 fixed at 45° there is formed a translucent hole 52 opened through the die pad 39, so that light emitted from the light emitting element 49 and converted by the mirror 51 fixed at 450 passes through the translucent hole 52 to the other side of the die pad 39 (corresponding to the surface on the right side in FIG. 3).

On the surface of the die pad 39 there is provided a projection lens 53 at a position such that the projection lens 53 and the translucent hole 52 have coinciding central axes. The projection lens 53 focuses the light, which is emitted from the light emitting element 49 and then passes through the translucent hole 52, into a required spot form. When the mirror 51 fixed at 45° provided near the translucent hole 52 is not in mirror form but in form of a prism, a similar light pass can be formed.

The projection lens 53 is fitted to a through hole 56 which is formed so as to pass through a front wall portion 55 of the light projection and photodetection package 33. In this case, the required focus adjustment for the projection lens 53 is conducted by sliding the projection lens 53 in the direction of the central axis of the through hole 56, and then, after adjustment of the focus, the outer periphery of the projection lens 53 is fixed by adhesion to an inner periphery of the through hole 56.

In the light projection and photodetection package 33 having the above-described construction, a light emitted from the light emitting element 49 is bent by 90° by the mirror 51 fixed at 45° and passes through the translucent hole 52, and then, is focused by the projection lens 53 shown in FIG. 3 and sent to the barcode printed on a package surface or the like (not shown). The light emitting element 49 may include a monitoring PD for controlling the laser output to a predetermined amount.

On the other hand, on the surface of the die pad 39 there is mounted a photodetecting element 57 contained in the cavity 43. On the surface of the die pad 39, a light receiving lens 59 is provided so as to face the photodetecting element 57. The light receiving lens 59 focuses the feedback light from the barcode to send it to the photodetecting element 57. The light receiving lens 59 is fitted to a fitting hole 61 which is formed so as to penetrate the front wall portion 55 of the light projection and photodetection package 33. Like in the case of the projection lens 53, the focus required is conducted by sliding the light receiving lens 59 in the direction of the central axis of the fitting hole 61, and then, after completion of the focus, the outer periphery of the light receiving lens 59 is fixed by adhesion to the inner periphery of the fitting hole 61.

The electrodes of the light emitting element 49 and the photodetecting element 57 are connected to lands 45 for wire bonding through bonding wires 63, as shown, for example, in FIG. 2 and FIG. 4. The individual electrodes of each of the light emitting element 49 and the photodetecting element 57 are lead out by means of the element leads 47 to the outside of the light projection and photodetection package 33. In other words, the light projection and photodetection package 33 collectively contains in a single resin package all the light emission and photodetection parts or sections and optical parts or sections for emitting scanning light and receiving feedback light.

The flexible thin sheet 37 having elastic properties and conductivity is fixed to each of the element leads 47 each being lead out to the outside of the light projection and photodetection package 33. This fixation is achieved by, for example, soldering. As a material for the thin sheet 37, phosphor bronze, beryllium bronze and the like may be used, each having elastic properties as well as high electrical conductivity and toughness.

As shown in FIG. 5, the flexible thin sheets 37 according to the present embodiment of the present invention are in a strip form and arranged in parallel on a same plane before being bent. The base end of each of the flexible thin sheets 37 is electrically connected by soldering to a fixed lead 65 provided in a fixed portion 35. The flexible thin sheets 37 are individually bent so that the respective intermediate portions as viewed in the longitudinal direction of the sheets as for example shown in FIG. 5 bend at a right angle to the strip planes. Thus, as shown in FIG. 1, the fixed leads 65, which are vertical, support the light projection and photodetection package 33 through the flexible thin sheets 37 bent at a right angle in such a way that the die pad 39 is horizontal, in the figure. The flexible thin sheets 37 have a elastic property, so that they pivotably support the light projection and photodetection package 33 in a direction of enlargement of reduction of the bending angle.

In other words, the flexible thin sheet 37 has not only a lead function to connect the electrodes of the light emitting element 49 and the photodetecting element 57 to the fixed lead 65 but also a hinge function to pivotably support the light projection and photodetection package 33.

On the outer periphery of the fixed lead 65 is formed a resin holder 67 by molding. Specifically, the fixed portion 35 keeps the fixed lead 65 by the resin holder 67, which is one constituent member thereof. The light projection and photodetection package 33, the resin holder 67, and the flexible thin sheet for connecting together the light projection and photodetection package 33 and the resin holder 67 may be prepared in an integrated form shown in FIG. 6 by a transfer molding method in which the flexible thin sheet 37 before being bent, for example, a thermosetting resin is plasticized in a heating chamber and pressed into a mold cavity heated to effect shaping.

The integrated optical apparatus 31 has a projection and photodetection package pivoting means 69 provided over both the light projection and photodetection package 33 and the fixed portion 35. The light projection and photodetection package pivoting means 69 comprises, for example, a magnetic material (magnet) 71 fixed to the light projection and photodetection package 33, and a driving coil 73 fixed to the fixed portion 35.

The magnetic material 71 is formed, for example, in a column or tube form, and provided on the lower surface of the light projection and photodetection package 33 (corresponding to the surface on the lower side in FIG. 1) so that it hangs vertically pointing to the fixed portion 35, in FIG. 1. The driving coil 73 is retained by the resin holder 67. As a result, the fixed portion 35 comprises the resin holder 67 adhering to the fixed lead 65, and the driving coil 73 retained by the resin holder 67. The magnetic material 71 vertically hanging from the light projection and photodetection package 33 is, as shown in FIG. 1, positioned at the hollow portion of the driving coil 73 in a way such that the flexible thin sheets 37 are bent.

When electrical current flows through the driving coil 73, a magnetic flux is generated thus causing an attracting force to the magnetic material 71, so that the light projection and photodetection package 33 moves in the direction of the fixed portion 35. When the attraction force disappears, the light projection and photodetection package 33 returns to the original portion due to the restoring force of the flexible thin sheets 37 elastically deformed. Therefore, by current flowing in opposite directions alternately in a predetermined cycle through the driving coil 73, the light projection and photodetection package 33 is allowed to attract and repel the fixed portion 35 alternately, so that the light projection and photodetection package 33 can be pivoted within a predetermined angle range.

With respect to the above-described integrated optical apparatus 31 constituted by combining in an integrated form the light projection and photodetection package 33 as an optical system and the fixed portion 35 as a driving system, the following may be mentioned as an example of use thereof. The fixed lead 65 lead out from the resin holder 67 is fixed to the circuit pattern of a circuit board 75 by soldering. Further, the terminal of the driving coil 73 is also fixed to the circuit pattern of the circuit board 75 by soldering, and thus, all the functional parts are integrated to constitute a single unit.

The integrated optical apparatus 31 itself comprises the light projection and photodetection package 33, the flexible thin sheet 37, and the fixed portion 35 which are combined in an integrated form. Therefore, other than the above-mentioned circuit board 75, the integrated optical apparatus may be directly fitted to the frame or the like of the main body apparatus.

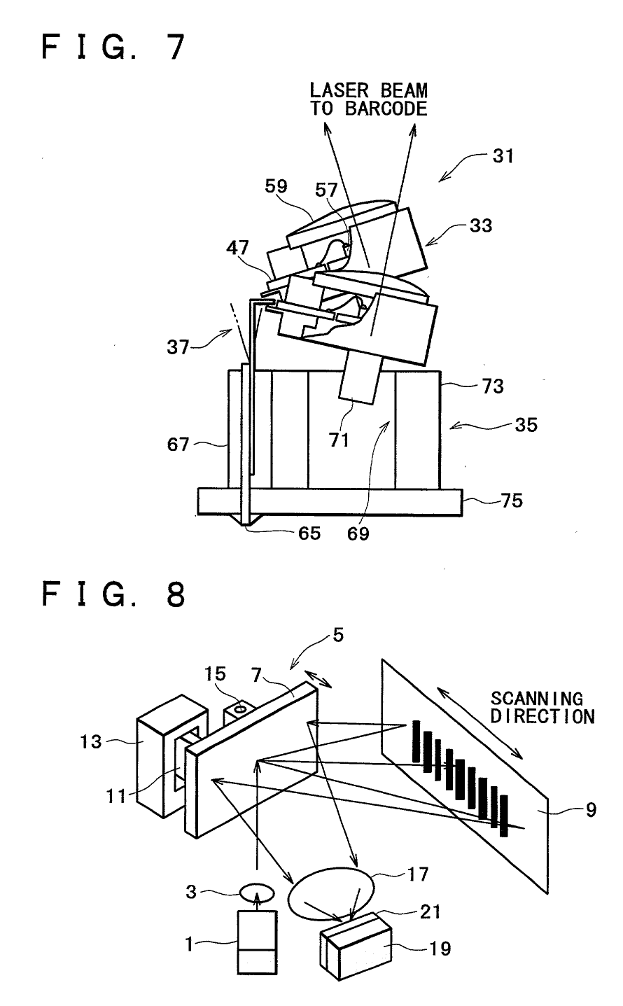

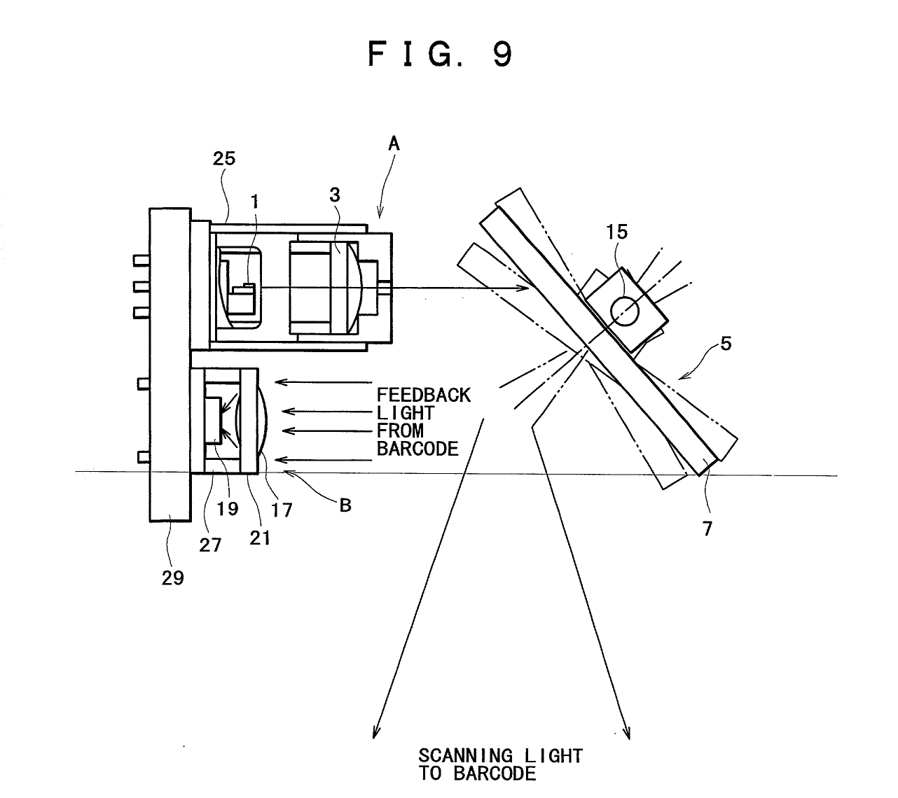

FIG. 7 is a diagrammatic cross-sectional view of an integrated optical apparatus, showing the projection and photodetection package being pivoted.

In the integrated optical apparatus 31 having the above construction, when the light emitting element 49 emits a light by means of a light emission driving circuit (not shown), the emitted light is focused (concentrated) by the projection lens 53 and then to be sent. The resultant light is sent to a barcode (not shown) to constitute a reflected light. At the same time, as shown in FIG. 7, the light projection and photodetection package 33 is pivoted through the flexible thin sheet 37 by means of the light projection and photodetection package pivoting means 69, so that the emitted light scans all over the barcode.

The light reflected by the barcode (feedback light) enters the light receiving lens 59 and is focused, and then enters the photodetecting element 57.

The photodetecting element 57 photoelectrically converts the light to output the pattern of the barcode to the element lead 47 as an electrical signal.

The output signal is sent to a not shown computer through the flexible thin sheet 37 and the fixed lead 65. The computer processes the signal to decode the barcode data.

As mentioned above, in the integrated optical apparatus 31 according to the preferred embodiment of the present invention, the light emitting element 49, the photodetecting element 57 and the like are contained in the light projection and photodetection package 33, the light projection and photodetection package 33 is supported to the fixed portion 35 through the flexible thin sheet 37, and the light projection and photodetection package pivoting means 69 is provided over both the light projection and photodetection package 33 and the fixed portion 35. Thus, the apparatus has an integrated structure. Further, the light projection and photodetection package 33 as one constituent of the apparatus can be directly pivoted. For this reason, a moving mirror and a frame for combining individual parts in an integrated form may be omitted. In addition, adjustment of the moving mirror may be also omitted. Further, since the frame can be omitted, not only can the size of the apparatus be reduced, but also the embedment property of the apparatus into the main body apparatus (flexibility for embedding the apparatus) is enhanced, thus increasing the design freedom of the apparatus.

Further, the element lead 47, which is lead out from the light projection and photodetection package 33, and the fixed lead 65 provided in the fixed portion 35 may be connected through the flexible thin sheet 37 comprised of conductive material. Therefore, the flexible thin sheet 37 not only serves as a hinge for pivotably supporting the light projection and photodetection package 33 but also electrically connects the light emitting element 49 and photodetecting element 57 to be pivoted. In other words, a pivotably supporting means can serve as an electric wiring means, thus making it possible to reduce the number of parts constituting the apparatus. In addition, connection is made possible through a flexible thin sheet 37 without a sliding part. Therefore, the apparatus suffers reduced abrasion or wear caused by an electric sliding part, realizing a pivotably and electrically connected structure having high fastness and relatively extended lifetime.

Although the invention having been described hereinabove in its preferred form with a certain degree of particularity, obviously many changes, variations, combinations and subcombinations are possible therein. It is therefore to be understood that the present invention may be practiced other than as specifically described herein without departing from the scope thereof.

Therefore, it has to be noted, for example, that in the above mentioned preferred embodiments of the present invention, although description having been made taking as an example a structure in which the element lead 47 and the fixed lead 65 are connected through the flexible thin sheet 37, the integrated optical apparatus may be alternatively formed from one single member. In such a structure, neither an element lead 47 nor a fixed lead 65 are required, so that the connection and fixing between the flexible thin sheet 37 and the element lead 47 and between the flexible thin sheet 37 and the fixed lead 65 by soldering or the like are not required. Thus, not only can the number of the parts used be further reduced, but also the reliability of the electrical connection and the reliability of the pivotably supported structure are further improved.

Furthermore, according to the above preferred embodiments of the present invention, although description having been made taking as an example the case where the magnetic material 71 is provided in the light projection and photodetection package 33 and the driving coil 73 is provided in the fixed portion 35, the integrated optical apparatus 31 may have a structure in which the driving coil 73 is provided in the light projection and photodetection package 33 and the magnetic material 71 is provided in the fixed portion 35. In such a structure, by virtue of providing the lightweight driving coil 73 in the light projection and photodetection package 33, not only the weight of the light projection and photodetection package 33 but also the driving force for the light projection and photodetection package 33 may be reduced as compared to the structure in which the magnetic material 71 is provided in the light projection and photodetection package 33.

As mentioned above, the integrated optical apparatus of the present invention is a apparatus having an integrated structure in which the light emitting element, the photodetecting element, and other optical systems are contained in the light projection and photodetection package, the light projection and photodetection package is supported to the fixed portion through the flexible thin sheet, and the light projection and photodetection package pivoting means is provided over both the light projection and photodetection package and the fixed portion. Thus, the apparatus has an integrated structure. Further, the light projection and photodetection package as one constituent of the apparatus can be directly pivoted. Therefore, a moving mirror and a frame for combining individual parts in an integrated form are no longer needed, thus achieving reduction in the size and weight of the apparatus. In addition, substantially no adjustment for the moving mirror is required. Therefore, the operations for assembly and adjustment can be simplified, making it possible to reduce the production cost. Further, since the frame can be omitted, not only can the size of the apparatus be reduced, but also the embedment property of the apparatus into the main body apparatus is enhanced, thus increasing the design freedom of the apparatus.

What is claimed is:

1. An integrated optical apparatus comprising:
a projection and photodetection package containing a light emitting element, a projection lens, a photodetecting element, and a light receiving lens;
a flexible thin sheet having elastic properties, wherein an end of said flexible thin sheet is fixed to said projection and photodetection package and a base end of said flexible thin sheet is fixed to a fixed portion for pivotably supportting said projection and photodetection package on said fixed portion; and
pivoting means for said projection and photodetection package, provided over both said projection and photodetection package and said fixed portion.

2. The integrated optical apparatus according to claim 1, wherein:
an element lead electrically connected to each of said light emitting element and said photodetecting element is lead out from said projection and photodetection package;
a fixed lead is provided in said fixed portion;
said flexible thin sheet is formed from a conductive material; and
said element lead and said fixed lead are connected and fixed through a plurality of said conductive flexible thin sheets.

3. The integrated optical apparatus according to claim 2, wherein said element lead, said conductive flexible thin sheet and said fixed lead are formed as an integrated body comprising an elastic and conductive material.

4. The integrated optical apparatus according to claim 2, wherein said projection and photodetection package pivoting means comprises a magnetic material fixed to said projection and photodetection package, and a driving coil fixed to said fixed portion.

5. The integrated optical apparatus according to claim 2, wherein said projection and photodetection package pivoting means comprises a driving coil fixed to said projection and photodetection package, and a magnetic material fixed to said fixed portion.
